(19) United States
(12) Patent Application Publication
(10) Pub. No.: US 2014/0226836 A1
(43) Pub. Date: Aug. 14, 2014

(54) VOICE INPUT DEVICE AND NOISE SUPPRESSION METHOD

(71) Applicant: Funai Electric Co., Ltd., Osaka (JP)

(72) Inventor: Kenshou MIYATAKE, Osaka (JP)

(73) Assignee: Funai Electric Co., Ltd., Osaka (JP)

(21) Appl. No.: 14/165,763

(22) Filed: Jan. 28, 2014

(30) Foreign Application Priority Data
Feb. 13, 2013 (JP) 2013-025244

(51) Int. Cl. H04R 3/00

(52) U.S. Cl. CPC H04R 3/002
USPC 381/94.1

(57) ABSTRACT

A voice input device includes a first microphone, a second microphone, and a processor. The second microphone has a lower distance decay rate than the first microphone. The processor is configured to acquire noise information of noise by comparing a first signal obtained from the first microphone with a second signal obtained from the second microphone. The processor is further configured to perform noise suppression processing based on the noise information.

### CROSS-REFERENCE TO RELATED APPLICATIONS

This application claims priority to Japanese Patent Application No. 2013-025244 filed on Feb. 13, 2013. The entire disclosure of Japanese Patent Application No. 2013-025244 is hereby incorporated herein by reference.

### BACKGROUND

1. Field of the Invention

This invention generally relates to a voice input device. This invention also relates to a noise suppression method applied to a voice input device.

2. Background Information

Generally, voice input devices are conventionally well known in the art. The voice input devices allow voice to be inputted and execute signal processing on the inputted voice. For example, voice input devices are applied to portable telephones, headsets, and other such voice communication devices, information processing systems that make use of technology for analyzing inputted voice (such as voice authentication systems, voice recognition systems, command generation systems, electronic dictionaries, translators, and voice input remote controls), recording devices, and so forth.

A voice input device such as this generally ends up taking in noise (e.g., background noise) generated at a distance, such as ambient noise or voices of other people, in addition to sound emitted from the intended sound source (such as a speaker's voice). If background noise is taken in, the result is that it a listener can find it difficult to hear a speaker's voice, leading to problems such as erroneous voice recognition.

Because of this, various methods for reducing noise have been disclosed in the past. For instance, Patent Literature 1 (Japanese Unexamined Patent Application Publication H7-193548) discloses a configuration in which control signals are formed and the details of the noise reduction processing are changed according to the detected noise level. With a configuration such as this, the amount of noise reduction can be appropriately adjusted, so a more natural reproduced sound is obtained.

### SUMMARY

With the noise reduction processing method disclosed in Patent Literature 1, information that has been stored ahead of time (e.g., information related to noise) is used to execute noise reduction processing. Therefore, it has been discovered that the noise reduction processing will not be carried out properly if, for example, some unexpected noise should be taken in. Also, it has been discovered that there is the risk that the job will be made more difficult because a large quantity of information has to be stored in advance.

One object is to provide a voice input device with which background noise generated at a distance can be accurately suppressed. Also, another object is to provide a noise suppression method applied to the voice input device.

In view of the state of the known technology, a voice input device is provided that includes a first microphone, a second microphone, and a processor. The second microphone has a lower distance decay rate than the first microphone. The processor is configured to acquire noise information of noise by comparing a first signal obtained from the first microphone with a second signal obtained from the second microphone. The processor is further configured to perform noise suppression processing based on the noise information.

Also other objects, features, aspects and advantages of the present disclosure will become apparent to those skilled in the art from the following detailed description, which, taken in conjunction with the annexed drawings, discloses one embodiment of the voice input device and the noise suppression method.

### BRIEF DESCRIPTION OF THE DRAWINGS

Referring now to the attached drawings which form a part of this original disclosure:

FIG. 1 is a perspective view of the external configuration of a headset in accordance with one embodiment;

FIG. 2 is a block diagram of the configuration of the headset illustrated in FIG. 1;

FIG. 3 is a front perspective view of the external configuration of a microphone unit of the headset illustrated in FIG. 1;

FIG. 4 is a rear perspective view of the external configuration of the microphone unit illustrated in FIG. 3;

FIG. 5 is an exploded perspective view of the microphone unit of the headset;

FIG. 6 is a cross sectional view of the microphone unit, taken along VI-VI line in FIG. 3;

FIG. 7 is a top plan view of a substrate component of the microphone unit of the headset;

FIG. 8 is a block diagram of the configuration of the microphone unit of the headset;

FIG. 9 is a graph illustrating a relation between sound pressure and distance from a sound source;

FIG. 10 is a diagram illustrating directional characteristics of a first microphone utilizing a first MEMS chip;

FIG. 11 is a diagram illustrating directional characteristics of a second microphone utilizing a second MEMS chip;

FIG. 12 is a graph illustrating distance decay characteristics of the first microphone and the second microphone;

FIG. 13 is a schematic graph illustrating an overview of performance in noise suppression executed with the headset;

FIG. 14 is a graph illustrating signals obtained when speech including background noise is inputted to the microphone unit of the headset;

FIG. 15 is a graph illustrating frequency characteristics of the first microphone and the second microphone;

FIG. 16 is a flowchart of a noise suppression method executed by the headset;

FIG. 17 is a graph illustrating a result obtained by FFT processing of signals acquired by the microphone unit of the headset;

FIG. 18 is a schematic graph illustrating an example of a filtering executed in the noise suppression method; and

FIG. 19 is a schematic graph illustrating another example of the filtering executed in the noise suppression method.

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

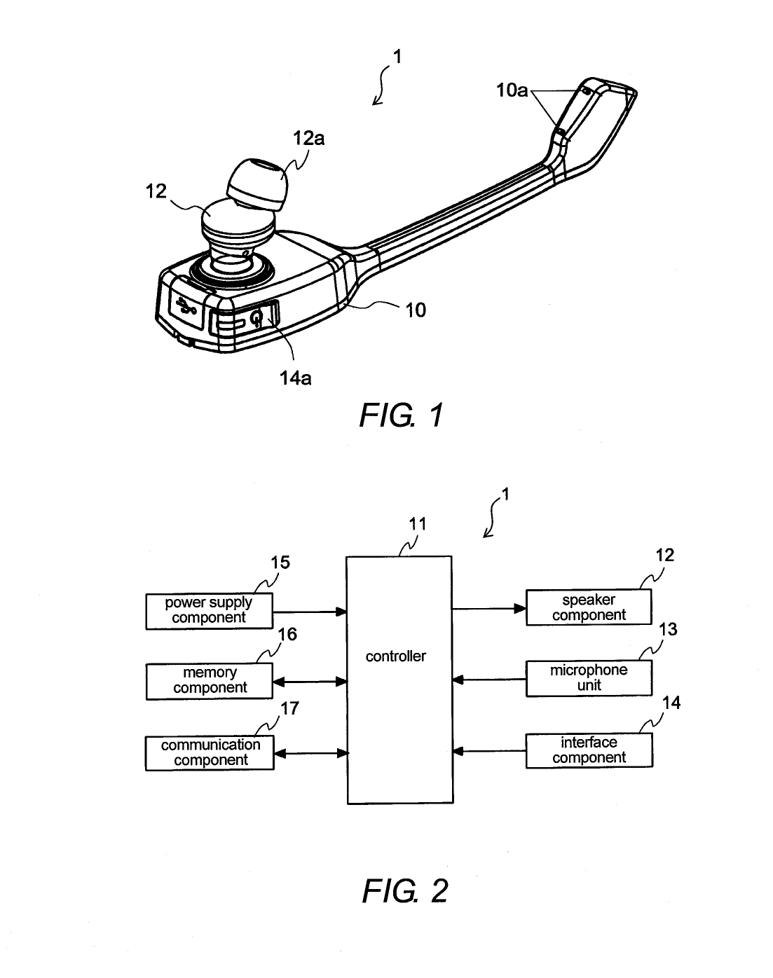

Referring to FIGS. 1 to 19, a headset 1 (e.g., a voice input device) and a noise suppression method are illustrated in accordance with one embodiment. In the illustrated embodiment, the headset 1 is an example of the voice input device of the present invention. In the illustrated embodiment, while the headset 1 is illustrated as an example of the voice input device, it will be apparent to those skilled in the art from this disclosure that the present invention can be applied to different types of voice input devices, such as portable telephones and other such voice communication devices, information processing systems that make use of technology for analyzing inputted voice (such as voice authentication systems, voice recognition systems, command generation systems, electronic dictionaries, translators, and voice input remote controls), recording devices, and so forth.

Referring now to FIG. 1, a general configuration of the headset 1 will be described. FIG. 1 is a simplified oblique view of the external configuration of the headset 1. The headset 1 basically has a housing 10, a controller 11 (see FIG. 2), a speaker component 12, and a microphone unit 13 (see FIG. 2). The housing 10 of the headset 1 is formed in a slender shape. The speaker component 12 is disposed at one end of this housing 10. The microphone unit 13 (see FIG. 2) is disposed at the other end. Two microphone sound holes 10a that allow sound to be inputted to the microphone unit 13 are formed on the side of the housing 10 where the microphone unit 13 is disposed. The headset 1 is used in a state in which an earpiece 12a provided to the distal end of the speaker component 12 is inserted into the user's ear opening, while the microphone sound holes 10a are disposed near the user's mouth. The headset 1 can be worn on a part of the user's body (ear, head, etc.) by means of a mounting mechanism (not shown).

FIG. 2 is a block diagram of the configuration of the headset 1. The controller 11 controls the various components of the headset 1, and controls the overall operation of the headset 1. The controller 11 executes a series of processing for suppressing noise (discussed in detail below). Specifically, the controller 11 is an example of the processor of the present invention. As shown in FIG. 2, as an internal configuration, the headset 1 basically includes the speaker component 12, the microphone unit 13, an interface component 14, a power supply component 15, a memory component 16, and a communication component 17.

The speaker component 12 outputs sound by converting electrical signals into physical vibrations. The microphone unit 13 converts inputted sound into electrical signals, and outputs the result. The detailed configuration of the microphone unit 13 will be discussed below. The interface component 14 is provided so that the user can operate the headset 1, and includes, for example, a power switch 14a (see FIG. 1), a volume switch (not shown), etc. The power supply component 15 supplies power for actuating the headset 1, and is made up of a secondary cell, for example. The memory component 16 holds various kinds of operational program, and temporarily stores various kinds of data during operation. The communication component 17 sends and receives voice information to and from the outside, either wirelessly or by wire.

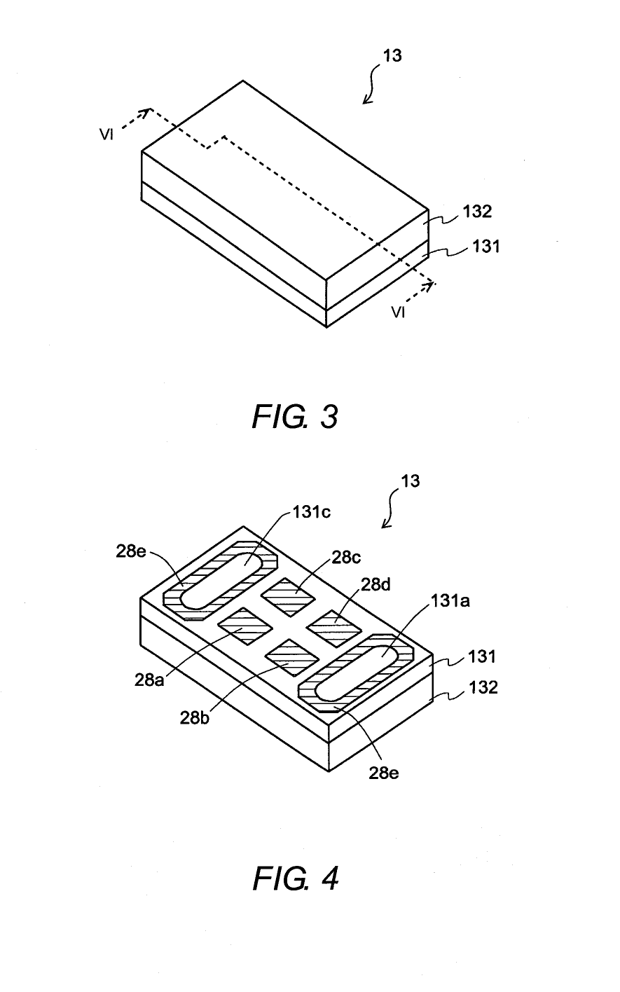

Referring now to FIG. 3, detailed configurations of the microphone unit 13 of the headset 1 will be described in detail. FIG. 3 is a simplified oblique view of the external configuration of the microphone unit 13 of the headset 1. FIG. 4 is a simplified oblique view of when the microphone unit 13 shown in FIG. 3 is seen from the rear. As shown in FIGS. 3 and 4, the microphone unit 13 is formed in a substantially cuboid external shape. The microphone unit 13 includes a substrate component 131 and a cover component 132 disposed on the substrate component 131.

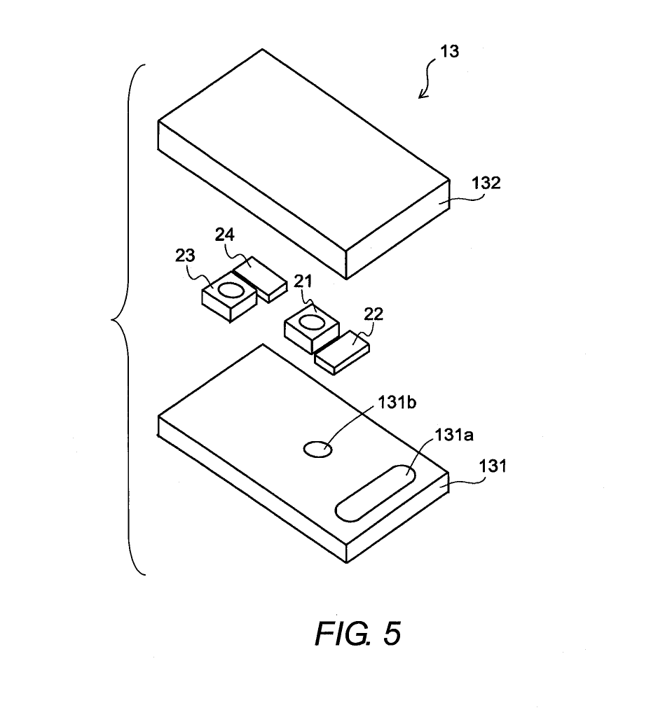

FIG. 5 is an exploded oblique view of the configuration of the microphone unit 13 of the headset 1. FIG. 6 is a simplified cross section taken along VI-VI line in FIG. 3. As shown in FIGS. 5 and 6, a through-hole 131a is formed at one end in the lengthwise direction of the substrate component 131 (the right end in FIGS. 5 and 6), which is provided in a substantially rectangular shape in plan view (see FIG. 4 as well). The through-hole 131a is substantially stadium-shaped (substantially rectangular) in plan view and passes through the substrate component 131 in the thickness direction.

Also, a first opening 131b is formed in the approximate center of the upper face of the substrate component 131 (the face on the side where the cover component 132 is installed). The first opening 131b is substantially circular in plan view. A second opening 131c is formed on the other end (the opposite side from the side where the through-hole 131a is formed) in the lengthwise direction of the lower face of the substrate component 131 (see FIG. 4 as well). The second opening 131c is substantially stadium-shaped in plan view. A substrate interior space 131d is formed in the interior of the substrate component 131. The substrate interior space 131d communicates between the first opening 131b and the second opening 131c inside the substrate component 131.

The substrate component 131 with this configuration can be formed by superposing a plurality of (such as three) substrates, although this is not intended to be particularly limiting.

As shown in FIGS. 5 and 6, the microphone unit 13 also includes a first MEMS (Micro Electro Mechanical System) chip 21, a first ASIC (Application Specific Integrated Circuit) 22, a second MEMS chip 23, and a second ASIC 24. The first MEMS chip 21 is disposed on the upper face of the substrate component 131 so as to cover the first opening 131b. Also, the first ASIC 22 is disposed on the upper face of the substrate component 131 so as to be adjacent to the first MEMS chip 21. The second MEMS chip 23 is disposed at the other end (in the lengthwise direction) of the upper face of the substrate component 131 (the opposite side from the side on which the through-hole 131a is formed). The second ASIC 24 is disposed on the upper face of the substrate component 131 so as to be adjacent to the second MEMS chip 23.

As shown in FIG. 6, the first MEMS chip 21 includes a diaphragm 21a and a fixed electrode 21b disposed opposite the diaphragm 21a at a specific spacing. Specifically, the first MEMS chip 21 forms a capacitor type of microphone chip. Similarly, the second MEMS chip 23 includes a diaphragm 23a and a fixed electrode 23b disposed opposite the diaphragm 23a at a specific spacing. The second MEMS chip 23 also forms a capacitor type of microphone chip. The first ASIC 22 amplifies the electrical signal that is taken off based on the change in electrostatic capacity of the first MEMS chip 21 (which originates in the vibration of the diaphragm 21a). The second ASIC 24 amplifies the electrical signal that is taken off based on the change in electrostatic capacity of the second MEMS chip 23 (which originates in the vibration of the diaphragm 23a).

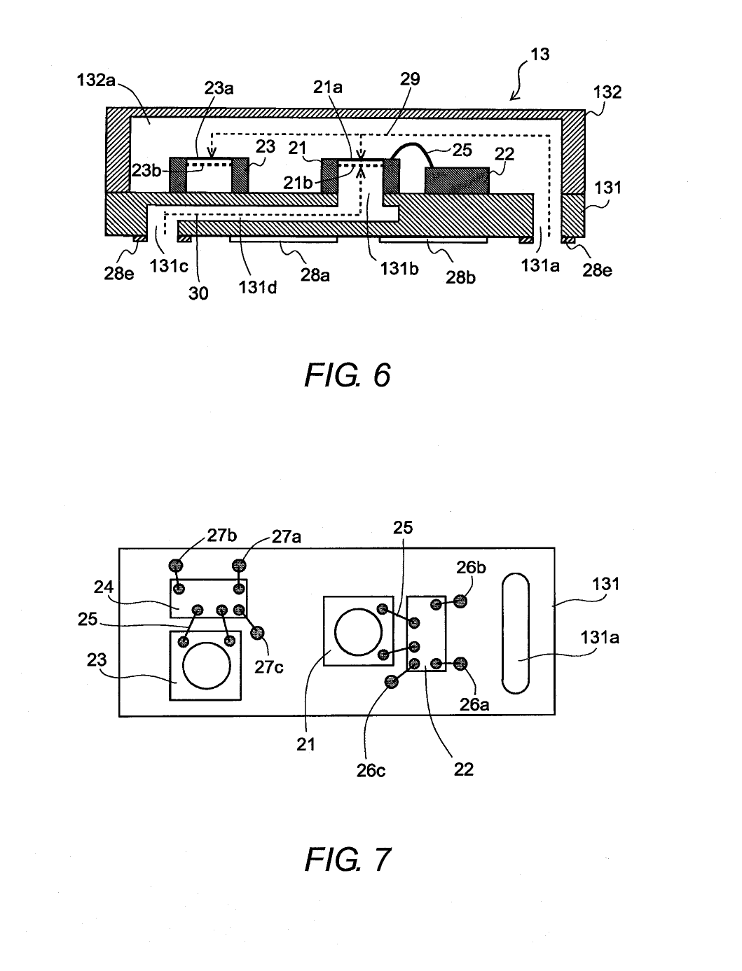

FIG. 7 is a simplified plan view of the substrate component 131 of the microphone unit 13 of the headset 1, as seen from above. A state in which the MEMS chips 21 and 23 and the ASICs 22 and 24 have been installed is shown here. The electrical connections and so forth of the MEMS chips 21 and 23 and the ASICs 22 and 24 will be described through reference to FIG. 7.

The two MEMS chips 21 and 23 and the two ASICs 22 and 24 are joined with a die bonding material (such as an epoxy or silicone resin-based adhesive) on the substrate component 131. The two MEMS chips 21 and 23 are joined on the substrate component 131 so that there will be no gap between their bottom faces and the upper face of the substrate component 131, in order to prevent acoustic leakage. The first MEMS chip 21 is electrically connected by a wire 25 (preferably a gold wire) to the first ASIC 22. Also, the second MEMS chip 23 is electrically connected by a wire 25 (preferably a gold wire) to the second ASIC 24.

The first ASIC 22 is electrically connected by wires 25 to a plurality of electrode terminals 26a, 26b, and 26c formed on the upper face of the substrate component 131. The electrode terminal 26a is a power supply terminal for inputting power supply voltage (VDD). The electrode terminal 26b is a first output terminal for outputting electrical signals that have been amplified by the first ASIC 22. The electrode terminal 26c is a ground terminal for making a ground connection.

Similarly, the second ASIC 24 is electrically connected by wires 25 to a plurality of electrode terminals 27a, 27b, and 27c formed on the upper face of the substrate component 131. The electrode terminal 27a is a power supply terminal for inputting power supply voltage (VDD). The electrode terminal 27b is a second output terminal for outputting electrical signals that have been amplified by the second ASIC 24. The electrode terminal 27c is a ground terminal for making a ground connection.

The electrode terminals 26a and 27a are electrically connected via wiring (not shown; includes through-wiring) to an external connection-use power supply pad 28a (see FIGS. 4 and 6) provided to the lower face of the substrate component 131. The first output terminal 26b is electrically connected via wiring (not shown; includes through-wiring) to an external connection-use first output pad 28b (see FIGS. 4 and 6) provided to the lower face of the substrate component 131. The second output terminal 27b is electrically connected via wiring (not shown; includes through-wiring) to an external connection-use second output pad 28c (see FIG. 4) provided to the lower face of the substrate component 131. The ground electrodes 26c and 27c are electrically connected via wiring (not shown; includes through-wiring) to an external connection-use ground pad 28d (see FIG. 4) provided to the lower face of the substrate component 131.

A sealing-use pad 28e (see FIG. 4) is provided to the lower face of the substrate component 131 so as to surround the through-hole 131a and the second opening 131c. This is used to prevent acoustic leakage when the microphone unit 13 is mounted to a mounting board (not shown) disposed inside the housing 10 of the headset 1.

Returning to FIG. 6, the cover component 132 is disposed (or covers) the substrate component 131 on which the two MEMS chips 21 and 23 and the two ASICs 22 and 24 are installed, the result of which is the microphone unit 13. The cover component 132 is provided with a concave space 132a. The cover component 132 is joined with an adhesive agent, an adhesive sheet, or the like on the substrate component 131 so that no acoustic leakage will occur. Also, the microphone unit 13 is disposed inside the housing 10 of the headset 1 in a state of having been mounted to a mounting board (not shown; in which is formed a sound hole for transmitting sound).

As shown in FIG. 6, with the microphone unit 13, sound waves inputted from the outside (through the microphone sound holes 10a of the headset 1 and the sound hole in the mounting board) are propagated into the interior through the through-hole 131a and the second opening 131c. Sound waves inputted from the through-hole 131a propagate through the concave space 132a of the cover component 132, reach the upper face of the diaphragm 21a of the first MEMS chip 21, and also reach the upper face of the diaphragm 23a of the second MEMS chip 23. Also, sound waves inputted from the second opening 131c propagates through the substrate interior space 131d and the first opening 131b and reaches the diaphragm 21a of the first MEMS chip 21.

A plurality of through-holes are formed in the fixed electrode 21b of the first MEMS chip 21, allowing sound waves to pass through the fixed electrode 21b. In the following description, the through-hole 131a will be referred to as a first sound hole, and the second opening 131c as a second sound hole, focusing on their functions.

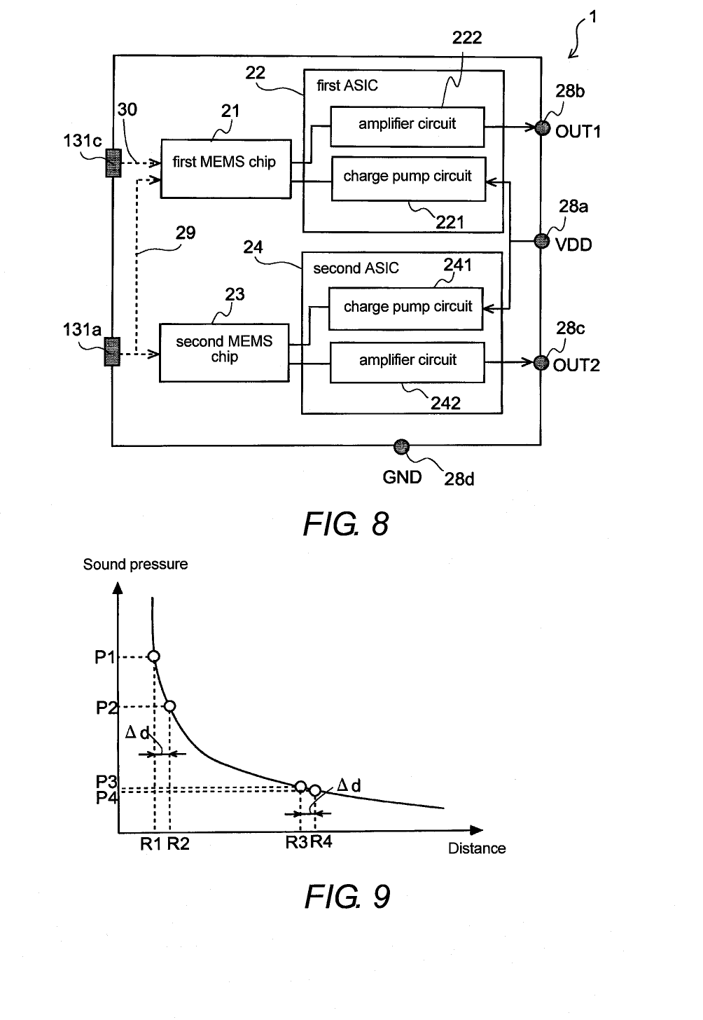

FIG. 8 is a block diagram of the configuration of the microphone unit 13 of the headset 1. As shown in FIG. 8, the first ASIC 22 includes a charge pump circuit 221 and an amplifier circuit 222. The charge pump circuit 221 applies bias voltage to the first MEMS chip 21. The charge pump circuit 221 boosts (about 6 to 10 V, for example) the power supply voltage (VDD; about 1.5 to 3 V, for example) supplied from the outside (the mounting board), and applies bias voltage to the first MEMS chip 21. The amplifier circuit 222 detects changes in the electrostatic capacity at the first MEMS chip 21. The electrical signal amplified by the amplifier circuit 222 is outputted (OUT1) to the outside (the mounting board).

Similarly, the second ASIC 24 includes a charge pump circuit 241 and an amplifier circuit 242. The charge pump circuit 241 applies bias voltage to the second MEMS chip 23. The amplifier circuit 242 detects changes in the electrostatic capacity and outputs (OUT2) the amplified electrical signal. The amplification gain of the two amplifier circuits 222 and 242 can be set as needed, and the gain settings can be different.

When sound is generated outside the microphone unit 13, the sound waves inputted from the first sound hole 131a go through a first sound channel 29 and arrive at the upper face of the diaphragm 21a of the first MEMS chip 21. The sound waves inputted from the second sound hole 131c go through a second sound channel 30 and arrive at the lower face of the diaphragm 21a of the first MEMS chip 21 (see FIG. 6 as well). The diaphragm 21a vibrates due to the sound pressure differential between the sound pressure applied to the upper face and the sound pressure applied to the lower face. This generation of vibration brings about a change in electrostatic capacity at the first MEMS chip 21. The electrical signal taken off based on the change in electrostatic capacity at the first MEMS chip 21 is amplified by the amplifier circuit 222 of the first ASIC 22, and is ultimately outputted from the first output pad 28b.

Also, when sound is generated outside the microphone unit 13, the sound waves inputted from the first sound hole 131a go through the first sound channel 29 and arrive at the upper face of the diaphragm 23a of the second MEMS chip 23 (see FIG. 6 as well). This causes the diaphragm 23a to vibrate, and this vibration changes the electrostatic capacity at the second MEMS chip 23. The electrical signal taken off based on the change in electrostatic capacity at the second MEMS chip 23 is amplified by the amplifier circuit 242 of the second ASIC 24, and is ultimately outputted from the second output pad 28c.

As can be understood from the above, with the microphone unit 13, signals obtained using the first MEMS chip 21 and signals obtained using the second MEMS chip 23 are outputted separately to the outside. In other words, the microphone unit 13 is configured to include two microphones in a single package. The first microphone utilizing the first MEMS chip 21 (corresponds to the first microphone of the present invention), and the second microphone utilizing the second MEMS chip 23 (corresponds to the second microphone of the present invention) have the following different characteristics.

Before describing the differences in the characteristics of the two microphones, the properties of sound waves will be described in simple terms. FIG. 9 is a graph of the relation between sound pressure and distance from a sound source. As shown in FIG. 9, as sound waves move through air or another such medium, the sound pressure (the strength and amplitude of the sound waves) decays. Sound pressure is inversely proportional to the distance from the sound source. The relation between the sound pressure P and the distance R is expressed by the following formula (1). In the formula (1), k is a proportional constant.

P=k/R (1)

As is clear from FIG. 9 and the formula (1), the sound pressure rapidly decays at a position near the sound source, and decays more slowly moving away from the sound source. Because of this, even at a given distance between two positions (Δd), it can be seen that the sound pressure will decay more between two positions (R1 and R2) that are closer to the sound source, and that the sound pressure will decay less between two positions (R3 and R4) that are farther away from the sound source.

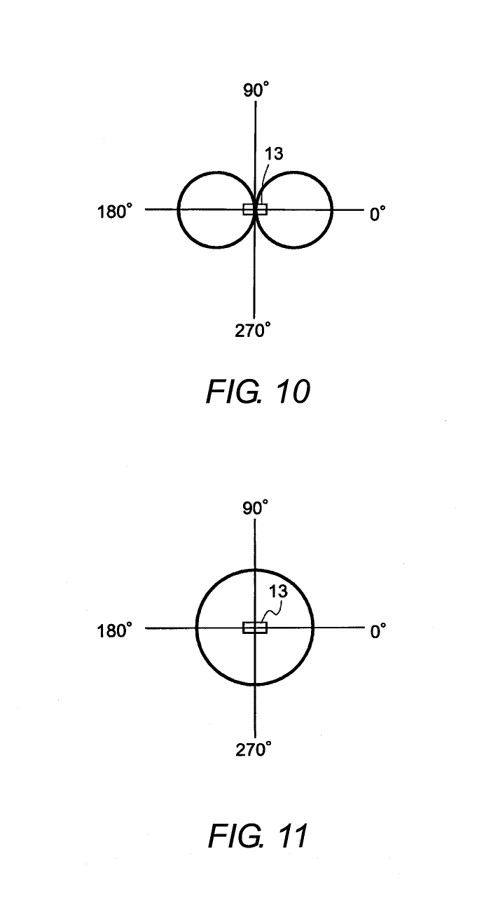

FIG. 10 is a simplified diagram of the directional characteristics of the first microphone utilizing the first MEMS chip 21. In FIG. 10, the orientation of the microphone unit 13 is assumed to be the same as that in FIG. 6. As long as the distance from the sound source to the diaphragm 21a is constant, the sound pressure exerted on the diaphragm 21a will be greatest when the sound source is at 0° or 180°. This is because the difference between the distance from the first sound hole 131a until the sound waves reach the upper face of the diaphragm 21a and the distance from the second sound hole 131c until the sound waves reach the lower face of the diaphragm 21a is also at its maximum.

In contrast, the sound pressure exerted on the diaphragm 21a will be lowest (0) when the sound source is at 90° or 270°. This is because the difference between the distance from the first sound hole 131a until the sound waves reach the upper face of the diaphragm 21a and the distance from the second sound hole 131c until the sound waves reach the lower face of the diaphragm 21a is substantially zero. Specifically, the first microphone is bidirectional, with high sensitivity to sound waves incident from a direction of 0° or 180°, and low sensitivity to sound waves incident from a direction of 90° or 270°.

FIG. 11 is a simplified diagram of the directional characteristics of the second microphone utilizing the second MEMS chip 23. In FIG. 11, the orientation of the microphone unit 13 is assumed to be the same as that in FIG. 6. As long as the distance from the sound source to the diaphragm 23a is constant, the sound pressure exerted on the diaphragm 23a will be constant regardless of the direction of the sound source. This can be attributed to the configuration of the second MEMS chip 23, in which sound waves inputted from the single sound hole 131a are received only at the upper face of the diaphragm 23a. Specifically, the second microphone is non-directional, uniformly receiving sound waves incident from all directions.

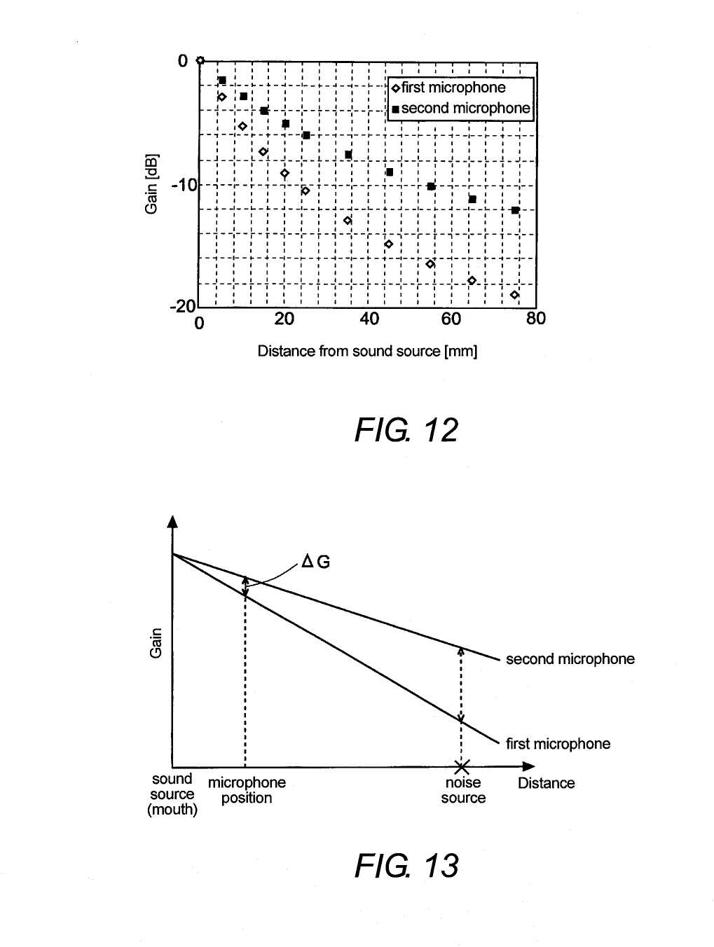

FIG. 12 is a graph of the distance decay characteristics of the first microphone and the second microphone. In the graph of FIG. 12, the horizontal axis is the distance from the sound source, and the vertical axis is the gain (microphone output). FIG. 12 shows the characteristics of sound of 250 Hz.

With the first MEMS chip 21, the diaphragm 21a vibrates due to the difference in the sound pressure exerted on its two sides (upper and lower faces). With the second MEMS chip 23, on the other hand, the diaphragm 23a vibrates due to the sound pressure exerted on one side (the upper face). With the second MEMS chip 23, the sound pressure level decays in inverse proportion to the distance (1/R, where R is the distance). With the first MEMS chip 21, on the other hand, the sound pressure level decays at 1/R². Accordingly, as shown in FIG. 12, with the first microphone utilizing the first MEMS chip 21, the proportional decrease in gain (signal strength) with respect to the distance from the sound source is steeper than with the second microphone utilizing the second MEMS chip 23. To put this another way, the second microphone has a lower distance decay rate than the first microphone.

Because it has the distance decay characteristics discussed above, the first microphone (differential microphone) utilizing the first MEMS chip 21 efficiently picks up sound generated near this microphone, but tends not to pick up background noise. That is, the first microphone functions as what is known as a close microphone. On the other hand, the second microphone utilizing the second MEMS chip 23 has the property of broadly picking up sound, even sound whose source is located farther away from this microphone.

The characteristics of the first microphone will now be described further. The sound pressure of the targeted sound generated near the first microphone (the microphone unit 13) decays more between the first sound hole 131a and the second sound hole 131c. Therefore, in the sound pressure of the targeted sound generated near the first microphone, a large difference occurs between the sound pressure at the upper face of the diaphragm 21a and the sound pressure at the lower face. Background noise, meanwhile, has a sound source that is located farther away than the target sound, so there is less decay between the first sound hole 131a and the second sound hole 131c. Accordingly, for background noise, there is a smaller difference between the sound pressure at the upper face of the diaphragm 21a and the sound pressure at the lower face. Here, we are assuming a case in which the distance from the sound source to the first sound hole 131a is different from the distance from the sound source to the second sound hole 131c.

Since there is little difference in the sound pressure of background noise received at the diaphragm 21a, the sound pressure of background noise is substantially cancelled out at the diaphragm 21a. By contrast, the sound pressure of the above-mentioned target sound is not cancelled out at the diaphragm 21a because there is the above-mentioned large difference in sound pressure of the target sound received at the diaphragm 21a. Therefore, the first microphone utilizing the first MEMS chip 21 has excellent performance in reducing the amount of background noise that is picked up, for target sound generated nearby.

Taking into account the above microphone characteristics, with the headset 1 (a close-talking voice input device), the signal outputted from the first microphone (close microphone) utilizing the first MEMS chip 21 is basically utilized as a voice signal of the speaker's voice. This does not mean, however, that background noise is completely eliminated by the first microphone. In view of this, the configuration is such that the second microphone utilizing the second MEMS chip 23 is utilized to further suppress the background noise component included in the signal outputted from the first microphone. The noise suppression function with which the headset 1 is equipped will now be described.

Referring now to FIG. 13, the noise suppression function will be described in detail. FIG. 13 is a simplified graph showing an overview of performance in noise suppression executed with the headset 1. The headset 1 is designed with the assumption that the microphone unit 13 will be a specific distance (such as within 25 to 100 mm) from the mouth (sound source) of the user (speaker). When the microphone unit 13 is disposed at this specific distance, a specific gain differential (signal strength differential) is caused by the difference in the above-mentioned distance decay characteristics between the first microphone utilizing the first MEMS chip 21 and the second microphone utilizing the second MEMS chip 23 (this corresponds to ΔG in FIG. 13).

Background noise generated separately from the speaker's voice occurs relatively far away (such as at least 250 mm from the microphone location). As discussed above, the sensitivity to background noise generated at a distance is different between the first microphone and second microphone. Specifically, the second microphone has considerably better sensitivity to background noise than the first microphone. Accordingly, when background noise occurs, the gain differential (Δg) between the first microphone and second microphone is greater than the above-mentioned ΔG.

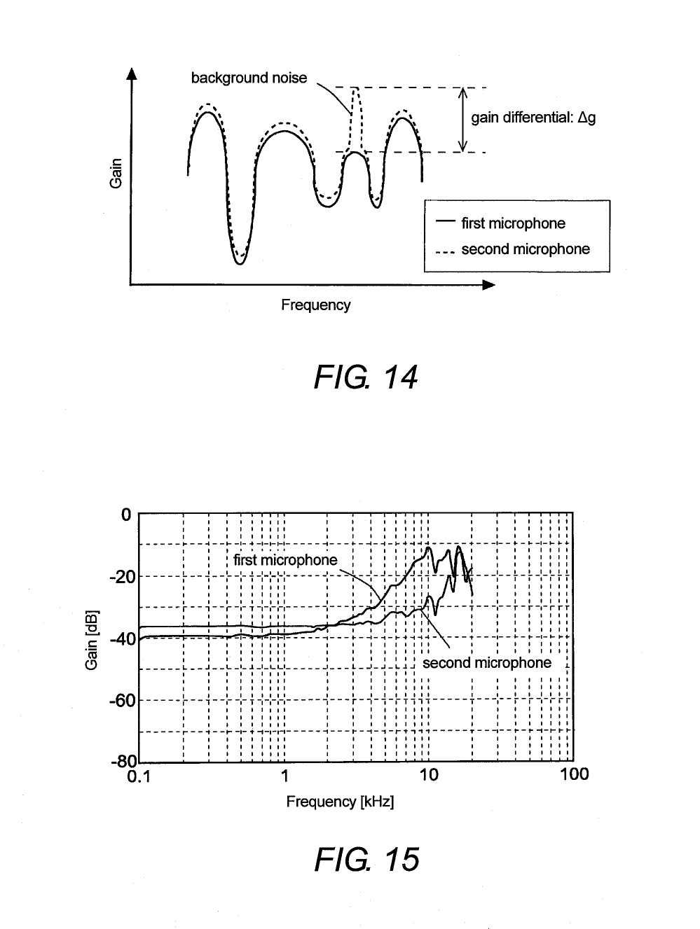

FIG. 14 is a simplified graph of signals obtained when speech including background noise is inputted to the microphone unit 13 of the headset 1. In FIG. 14, the horizontal axis (logarithmic axis) is frequency, and the vertical axis is gain (microphone output). As shown in FIG. 14, when background noise occurs, a frequency band occurs in which the difference (Δg) in the gain values (signal strength) between the first microphone and the second microphone is greater than ΔG. Specifically, the frequency band in which background noise is included can be determined by finding the difference (Δg) in the gain values between the first microphone and the second microphone, and determining whether or not Δg is greater than ΔG.

Actually, however, it is conceivable, for example, that the distance from the sound source (the mouth of the speaker) to the position of the microphone unit 13 will include a certain amount of error. Therefore, in the illustrated embodiment a threshold is determined that includes an allowance α determined by taking into account this error, etc., and the distance decay characteristics (an example of which is shown in FIG. 12). Specifically, in the illustrated embodiment, when the following formula (2) is satisfied, it is concluded that background noise is being generated.

Δg≧ΔG+α (2)

The allowance α can also be selected by the user. There are users who are not expected to need background noise to be suppressed, because they want to hear speech in as natural a sound as possible, or for some other such reason, as well as users who want all of the background noise to be eliminated. The various needs of different users can be easily accommodated by readying a plurality of stages for the allowance α.

FIG. 15 is a graph of the frequency characteristics of the first microphone and the second microphone. In the graph shown in FIG. 15, the horizontal axis (logarithmic axis) is frequency, and the vertical axis is gain (microphone output). FIG. 15 also shows the characteristics when the distance from the sound source is 25 mm.

As can be seen from FIG. 15, to be exact, the above-mentioned ΔG fluctuates with frequency. Accordingly, the method for identifying the frequency band in which the above-mentioned background noise is being generated can, for example, be utilized in a range in which ΔG does not fluctuate substantially (in FIG. 15, for instance, the range is about 100 Hz to a few kilohertz, but this range can vary with the design of the microphone). Also, apart from this, the method for identifying the frequency band in which the above-mentioned background noise is being generated can involve varying the ΔG that determines the threshold (expressed by the formula (2), for example) depending on the frequency of the sound waves.

If the frequency band in which background noise is being generated has been identified, noise suppression can be carried out by performing processing to remove signals of that frequency band, or reduce the signal strength. Therefore, in this embodiment, the controller 11 (see FIG. 2) is configured so as to perform filtering (digital filtering) on the identified frequency band (can be more than one).

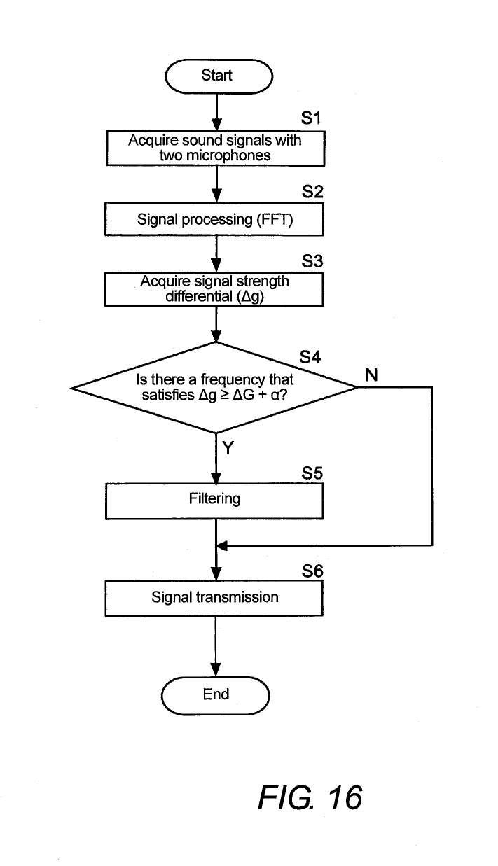

FIG. 16 is a flowchart of the flow in the noise suppression method executed by the headset 1. The noise suppression method in this embodiment is commenced by acquiring a sound signal (speech) with the microphone unit 13 (step S1). Since the microphone unit 13 includes the first microphone utilizing the first MEMS chip 21 and the second microphone utilizing the second MEMS chip 23, the sound signal is acquired by both of these.

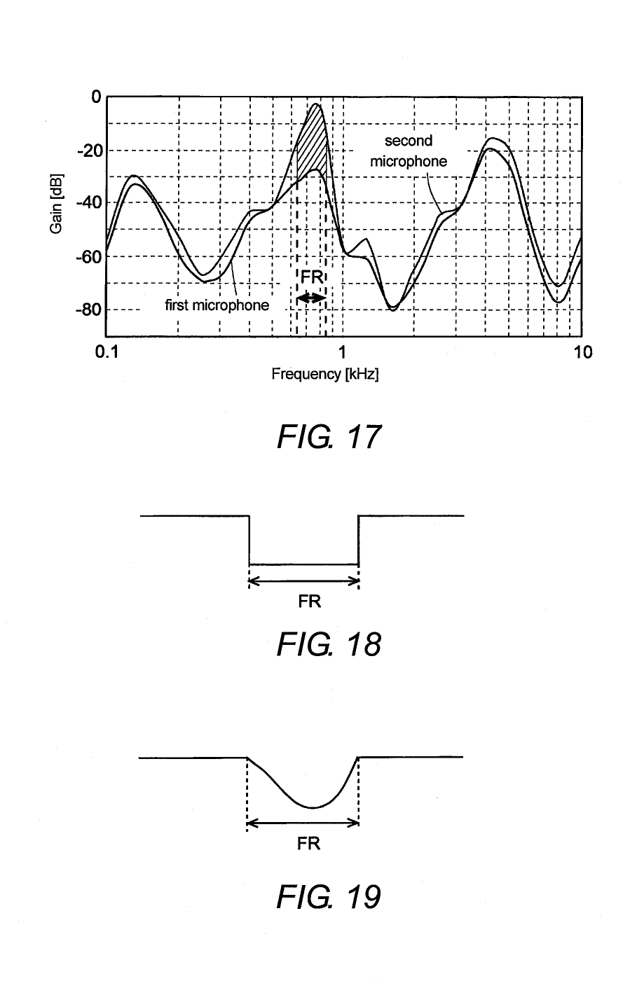

The signal outputted by the first microphone and the signal outputted by the second microphone are both outputted to the controller 11 (see FIG. 2). The controller 11 then subjects each signal to fast Fourier transform (FFT) processing (step S2). This signal processing gives the results shown in FIG. 17, for example. FIG. 17 is an example of the results obtained by FFT processing of signals acquired by the microphone unit 13 of the headset 1. In FIG. 17, the horizontal axis (logarithmic axis) is frequency, and the vertical axis is gain (microphone output).

In this embodiment, the configuration is such that FFT processing is executed on the signal outputted from the first microphone and on the signal outputted from the second microphone. However, this processing can instead be discrete Fourier transform (DFT). The first signal obtained by subjecting the signal outputted from the first microphone to FFT (or DFT) processing corresponds to the first signal of the present invention. The second signal obtained by subjecting the signal outputted from the second microphone to FFT (or DFT) processing corresponds to the second signal of the present invention.

When FFT (or DFT) processing is executed, the controller 11 compares the first signal and the second signal at each frequency. More precisely, the controller 11 calculates the difference (Δg; absolute value) in signal strength between the first signal and the second signal for each frequency (step S3). The controller 11 then checks whether or not there is a frequency that satisfies the above-mentioned formula (2) (i.e., Δg≧ΔG+α), from the obtained difference (Δg) in signal strength (step S4).

If there is a frequency that satisfies the formula (2) (Yes in step S4), then the controller 11 concludes (identifies) that noise is included in that frequency. In the example shown in FIG. 17, the range indicated by hatching corresponds to a frequency band that includes noise. The controller 11 performs filtering on the frequency band (FR) that includes noise in the first signal, and eliminates signals of that frequency band, or reduces the signal strength (step S5).

When filtering is executed, the controller 11 controls the communication component 17 to send the filtered signal to the transmission destination (the partner communicating with the headset 1 (step S6). If there is no frequency that satisfies the formula (2) (No in step S4), the controller 11 concludes that the sound signal inputted to the first microphone does not include any noise. Therefore, the signal (first signal) is sent to the transmission destination without undergoing the filtering of step S5.

This filtering will now be described in a bit more detail. FIG. 18 illustrates an example of the filtering executed in the noise suppression method. As shown in FIG. 18, the filtering performed on the frequency band FR that includes noise can have a square waveform. The level to which the noise is suppressed can be adjusted by adjusting the signal strength of the square wave.

FIG. 19 illustrates another example of the filtering executed in the noise suppression method. As shown in FIG. 19, the waveform of the filtering performed on the frequency band FR that includes noise need not be a square wave. For example, the waveform of the filtering can be determined according to the size of the background noise estimated from the size of the difference between the first signal (the signal obtained from the first microphone) and the second signal (the signal obtained from the second microphone). It is anticipated that this will allow the user to perceive speech transmitted from the headset 1 as a more natural sound.

A plurality of types of configuration can be readied for the waveform of the filtering, and the user can select the appropriate one. This makes it possible to use the headset 1 in a way that suits the preferences of the user.

The headset 1 in this embodiment includes a noise suppression function as described above (a function of suppressing noise included in speech picked up by the microphones). Accordingly, with the headset 1 in this embodiment, background noise can be accurately eliminated without storing numerous noise patterns ahead of time.

The embodiment given above is an example of the present invention, and the applicable scope of the present invention is not limited to or by the configuration of the embodiment given above. Naturally, the above embodiment can be suitably modified without exceeding the technological concept of the present invention.

For example, the configuration of the microphone unit 13 given above is just one example, and various modifications are possible. For instance, in the above configuration, the sound holes 131a and 131c of the microphone unit 13 are provided on the substrate component 131 side. However, the configuration can instead be such that the sound holes of the microphone unit 13 are provided on the cover component 132 side, for example.

Also, in the illustrated embodiment, the microphone unit 13 includes the first microphone (close microphone) and the second microphone (non-directional microphone) in a single package. However, the first microphone and second microphone do not need to be configured within a single package, and can be configured separately.

Also, in the illustrated embodiment, the first microphone is configured as a differential microphone converting input sound into electrical signals by vibrating the single diaphragm based on the differential in sound pressure exerted on the two sides of the single diaphragm. However, the first microphone can be configured as a differential microphone having a plurality of diaphragms.

Also, in the illustrated embodiment, the signal filtered when background noise occurred is the signal obtained from the first microphone (close microphone). The present invention, however, is not limited to this configuration. The signal filtered when background noise occurs can be the signal obtained from the second microphone (non-directional microphone).

Also, in the illustrated embodiment, the present invention is applied to the headset, but the present invention is not limited to the headset. The present invention can instead be applied to a portable telephone or another such speech communication device, an information processing system (such as a voice recognition system or a translator), a recording device, or the like.

In the illustrated embodiment, the controller 11 preferably includes a microcomputer with a control program that controls the various components as discussed above. The controller 11 can include other conventional components such as an input interface circuit, an output interface circuit, and storage devices such as a ROM (Read Only Memory) device and a RAM (Random Access Memory) device. The microcomputer of the controller 11 is programmed to control the various components. The internal RAM of the controller 11 can stores statuses of operational flags and various control data. The internal ROM of the controller 11 can stores programs for various operations. The controller 11 is capable of selectively controlling any of the components of the headset 1. It will be apparent to those skilled in the art from this disclosure that the precise structure and algorithms for the controller 11 can be any combination of hardware and software that will carry out the functions.

In the illustrated embodiment, a voice input device includes a first microphone, a second microphone, and a processor. The second microphone has a lower distance decay rate than the first microphone. The processor is configured or programmed to acquire noise information of noise by comparing a first signal obtained from the first microphone with a second signal obtained from the second microphone. The processor is further configured or programmed to perform noise suppression processing based on the noise information.

With this configuration, the noise is suppressed by acquiring the noise information by comparing signals obtained from two microphones with different distance decay rates. Therefore, less data needs to be readied in advance in order to suppress the noise, and the noise suppression can be carried out more accurately.

With the voice input device, the noise information can be information related to frequencies of the noise (e.g., frequencies included in the noise). The noise suppression processing can include performing filtering to suppress signal strength of the frequencies of the noise. With this configuration, for example, the noise information can be simply acquired by utilizing fast Fourier transform processing or the like, and the noise can be suppressed by utilizing digital processing.

With the voice input device, the processor can be further configured or programmed to identify the frequencies of the noise by comparing the magnitude relation between a specific threshold and an error amount between signal strength of the first signal and signal strength of the second signal. With this configuration, the specific threshold can be obtained, for example, by taking into account the distance decay characteristics of the two different microphones, the distance from the sound sources of these microphones, etc. (error, for example, can also be taken into account), and the specific threshold can be suitably determined in the design of the device.

With the voice input device, the filtering can be performed on the first signal. With this configuration, the signal from the first microphone having greater distance decay characteristics (i.e., better performance of suppressing remote noise than the second microphone) is utilized as the signal that indicates input sound that is inputted to the voice input device. This configuration is favorable for close-talking voice input devices.

With the voice input device, the first microphone can include a differential microphone, and the second microphone can include a non-directional microphone. With this configuration, the difference in sensitivity to background noise generated at a distance is increased, which makes it easier to suppress noise.

With the voice input device, the first microphone is configured to convert input sound into an electrical signal by vibrating a diaphragm based on the difference between sound pressure applied to one side of the diaphragm and sound pressure applied to the other side. With this configuration, less space is needed for the first microphone. Thus, the voice input device can easily be made more compact.

With the voice input device, the first microphone and the second microphone can be disposed in a single package. With this configuration, the voice input device can easily be made more compact.

With the voice input device, the first microphone and the second microphone can be disposed on a single substrate component.

With the voice input device, the first microphone and the second microphone can be arranged relative to first and second sound channels at least partially defined by the substrate component. The first microphone has a diaphragm that communicates with the first and second sound channels on both sides of the diaphragm of the first microphone. The second microphone has a diaphragm that only communicates with the first sound channel on one side of the diaphragm of the second microphone.

In the illustrated embodiment, the noise suppression method is executed by a voice input device. The noise suppression method includes identifying frequencies of noise by comparing a first signal obtained from a first microphone with a second signal obtained from a second microphone. The second microphone has a lower distance decay rate than the first microphone. The noise suppression method further includes performing filtering to suppress signal strength of the frequencies of the noise that has been identified.

With this configuration, the frequencies of the noise are identified by comparing signals obtained from two types of microphone with different distance decay rates. The noise is suppressed by suppressing the signal strength of frequencies identified as including noise. Therefore, less data needs to be readied in advance in order to suppress noise, and noise suppression can be carried out more accurately.

The present invention provides a voice input device and a noise suppression method with which background noise generated at a distance can be accurately suppressed.

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts unless otherwise stated.

Also it will be understood that although the terms “first” and “second” may be used herein to describe various components these components should not be limited by these terms. These terms are only used to distinguish one component from another. Thus, for example, a first component discussed above could be termed a second component and vice-a-versa without departing from the teachings of the present invention. The term “attached” or “attaching”, as used herein, encompasses configurations in which an element is directly secured to another element by affixing the element directly to the other element; configurations in which the element is indirectly secured to the other element by affixing the element to the intermediate member(s) which in turn are affixed to the other element; and configurations in which one element is integral with another element, i.e. one element is essentially part of the other element. This definition also applies to words of similar meaning, for example, “joined”, “connected”, “coupled”, “mounted”, “bonded”, “fixed” and their derivatives. Finally, terms of degree such as “substantially”, “about” and “approximately” as used herein mean an amount of deviation of the modified term such that the end result is not significantly changed.

While only a selected embodiment has been chosen to illustrate the present invention, it will be apparent to those skilled in the art from this disclosure that various changes and modifications can be made herein without departing from the scope of the invention as defined in the appended claims. For example, unless specifically stated otherwise, the size, shape, location or orientation of the various components can be changed as needed and/or desired so long as the changes do not substantially affect their intended function. Unless specifically stated otherwise, components that are shown directly connected or contacting each other can have intermediate structures disposed between them so long as the changes do not substantially affect their intended function. The functions of one element can be performed by two, and vice versa unless specifically stated otherwise. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiment according to the present invention are provided for illustration only, and not for the purpose of limiting the invention as defined by the appended claims and their equivalents.

What is claimed is:

1. A voice input device comprising:
a first microphone;
a second microphone having a lower distance decay rate than the first microphone; and
a processor configured to acquire noise information of noise by comparing a first signal obtained from the first microphone with a second signal obtained from the second microphone, the processor being further configured to perform noise suppression processing based on the noise information.

2. The voice input device according to claim 1, wherein
the processor is further configured to acquire information related to frequencies of the noise as the noise information, and
the processor is further configured to perform filtering to suppress signal strength of the frequencies of the noise as the noise suppression processing.

3. The voice input device according to claim 2, wherein
the processor is further configured to identify the frequencies of the noise by comparing an error amount between signal strength of the first signal and signal strength of the second signal with a specific threshold.

4. The voice input device according to claim 2, wherein
the processor is further configured to perform the filtering on the first signal.

5. The voice input device according to claim 1, wherein
the first microphone includes a differential microphone, and
the second microphone includes a non-directional microphone.

6. The voice input device according to claim 5, wherein
the first microphone is configured to convert input sound into an electrical signal by vibrating a diaphragm based on difference between sound pressure applied to one side of the diaphragm and sound pressure applied to the other side.

7. The voice input device according to claim 1, wherein
the first microphone and the second microphone are disposed in a single package.

8. The voice input device according to claim 1, wherein
the first microphone and the second microphone are disposed on a single substrate component.

9. The voice input device according to claim 8, wherein
the first microphone and the second microphone are arranged relative to first and second sound channels at least partially defined by the substrate component, the first microphone having a diaphragm that communicates with the first and second sound channels on both sides of the diaphragm of the first microphone, the second microphone having a diaphragm that only communicates with the first sound channel on one side of the diaphragm of the second microphone.

10. A noise suppression method for a voice input device, the method comprising:
identifying frequencies of noise by comparing a first signal obtained from a first microphone with a second signal obtained from a second microphone, with the second microphone having a lower distance decay rate than the first microphone; and
performing filtering to suppress signal strength of the frequencies of the noise that has been identified.
